(19) United States
(12) Patent Application Publication
(10) Pub. No.: US 2015/0011789 A1
(43) Pub. Date: Jan. 8, 2015

(54) Process for the Preparation of Palladium Intermetallic Compounds and Use of the Compounds to Prepare Organohalosilanes

(71) Applicant: Dow Corning Corporation, Midland, MI (US)

(72) Inventors: Aswini Dash, Midland, MI (US); Dimitris Katsoulis, Midland, MI (US)

(73) Assignee: Dow Corning Corporation, Midland, MI (US)

(21) Appl. No.: 14/382,006

(22) PCT Filed: Mar. 7, 2013
(86) PCT No.: PCT/US13/29552

§ 371 Date: Aug. 29, 2014

Related U.S. Application Data
(60) Provisional application No. 61/624,423, filed on Apr. 16, 2012.

(51) Int. Cl. B01J 27/13; C07F 7/12

(52) U.S. Cl. CPC B01J 27/13; C07F 7/125
USPC 556/472; 502/230; 502/225

(57) ABSTRACT

Palladium intermetallic compounds, such as palladium silicides, e.g., PdSi and/or Pd₂Si, can be selectively prepared in a two step process including the steps of (1) vacuum impregnating silicon with a metal halide comprising a palladium halide, and (2) ball milling the product of step (1). A method of preparing organohalosilanes may be performed combining an organohalide having the formula RX, where R is a hydrocarbyl group having 1 to 10 carbon atoms and X is a halogen atom, with a contact mass comprising at least 2% of the palladium intermetallic compound.

### TECHNICAL FIELD

A process selectively produces an intermetallic compound, such as a palladium silicide and an intermetallic compound comprising Cu, Pd, and Si. The intermetallic compound can be used as a catalyst for preparing organohalosilanes. A method of using the intermetallic compound comprises combining an organohalide with a contact mass to form an organohalosilane, where the contact mass comprises at least 2% of the intermetallic compound.

### BACKGROUND

Methods of preparing organohalosilanes are known in the art. Typically, organohalosilanes are produced commercially by the Mueller-Rochow Direct Process, which comprises passing an organohalide over zero-valent silicon in the presence of a copper catalyst and various optional promoters. A mixture of organohalosilanes, the most important of which is dimethyldichlorosilane, are produced by the Direct Process.

The typical process for making the zero-valent silicon used in the Direct Process consists of the carbothermic reduction of SiO₂ in an electric arc furnace. Extremely high temperatures are required to reduce the SiO₂, so the process is very energy intensive. Consequently, production of zero-valent silicon adds costs to the Direct Process for producing organohalosilanes. Therefore, there is a need for a more economical method of producing organohalosilanes that avoids or reduces the need of using zero-valent silicon.

Another method for preparing organohalosilanes comprises combining an organohalide with a contact mass to form the organohalosilane, where the contact mass includes a metal silicide. WO2011/094140 mentions a method of preparing organohalosilanes comprising combining an organohalide having the formula RX (I), wherein R is a hydrocarbyl group having 1 to 10 carbon atoms and X is Br, Cl, F, and I, with a contact mass comprising at least 2% of a palladium silicide of the formula PdₓSi_{y} (II), wherein x is an integer from 1 to 5 and y is 1 to 8, or a platinum silicide of formula Pt_{z}Si (III), wherein z is 1 or 2, in a reactor at a temperature from 250 to 700° C. to form an organohalosilane.

### BRIEF SUMMARY OF THE INVENTION

A process for preparing an intermetallic compound comprises:
(1) vacuum impregnating a metal halide comprising a palladium halide of formula PdX′₂, where X′ is a halogen atom, on silicon particles thereby producing a mixture, and
(2) mechanochemically processing the mixture under an inert atmosphere, thereby producing a reaction product comprising the intermetallic compound. The intermetallic compound comprised Pd and Si.

A method of preparing an organohalosilane comprises: combining an organohalide having the formula RX″, where R is a hydrocarbyl group having 1 to 10 carbon atoms and X″ is a halogen atom, with a contact mass comprising at least 2% of the intermetallic compound prepared by the process described above at a temperature ranging from 250° C. to 700° C. to form an organohalosilane.

### DETAILED DESCRIPTION OF THE INVENTION

The Brief Summary of the Invention and the Abstract of the Disclosure are hereby incorporated by reference. All ratios, percentages, and other amounts are by weight, unless otherwise indicated. The articles “a”, “an”, and “the” each refer to one or more, unless otherwise indicated by the context of the specification. Abbreviations used herein are defined in Table 1, below.

TABLE 1
Abbreviations

| Abbreviation | Word |
|---|---|
| % | percent |
| ° C. | degrees Celsius |
| EDS | energy dispersive spectroscopy |
| g | gram |
| h | hour |
| ICP | inductively coupled plasma |
| kPa | kiloPascals |
| mL | milliliters |
| RT | room temperature of 23° C. |
| sccm | standard cubic centimeters per minute |
| SEM | scanning electron microscopy |
| μm | micrometers |
| XRD | x-ray diffraction |

The disclosure of ranges includes the range itself and also anything subsumed therein, as well as endpoints. For example, disclosure of a range of 2.0 to 4.0 includes not only the range of 2.0 to 4.0, but also 2.1, 2.3, 3.4, 3.5, and 4.0 individually, as well as any other number subsumed in the range. Furthermore, disclosure of a range of, for example, 2.0 to 4.0 includes the subsets of, for example, 2.1 to 3.5, 2.3 to 3.4, 2.6 to 3.7, and 3.8 to 4.0, as well as any other subset subsumed in the range. Similarly, the disclosure of Markush groups includes the entire group and also any individual members and subgroups subsumed therein. For example, disclosure of the Markush group, Br, Cl, F, and I includes the member Br individually; the subgroup CI and I; and any other individual member and subgroup subsumed therein.

“Contact time” means the residence time of gas to pass through a reactor.

“Mechanochemical processing” means applying mechanical energy to initiate chemical reactions and/or structural changes. Mechanochemical processing may be performed, for example, by techniques such as milling, e.g., ball milling. Milling may be performed using any convenient milling equipment such as a mixer mill, planetary mill, attritor, or ball mill. Mechanochemical processing may be performed, for example, using the methods and equipment described in, “Mechanical alloying and milling” by C. Suryanarayana, Progress in Materials Science 46 (2000) 1-184.

### Process for Making Intermetallic Compounds

A process comprises:
(1) vacuum impregnating a halide comprising a palladium halide of formula PdX′₂ on silicon, where X′ is as defined above, thereby producing a mixture comprising Pd_{z}Si_{w}X′_{zq}, where z represents the molar amount of Pd, w represents the molar amount of Si and zq represents a relative molar amount of the halogen atoms in the mixture; and
(2) mechanochemically processing of the mixture prepared in step (1) under an inert atmosphere, thereby producing a redox reaction product comprising
   (i) an intermetallic compound of formula Pd_{z}Si_{(w-y/4)}X′_{(zq-y)}, where y/4 represents a molar amount of Si removed from the mixture during step (2) and y represents a molar amount of halogen atom removed from the mixture during step (2), and y<zq;

Step (1) of the process involves vacuum impregnation of a metal halide on silicon (Si) particles. The metal halide comprises a palladium halide of formula PdX′₂, where each X′ is independently a halogen atom. X′ may be selected from Br, Cl, F, or I. Alternatively, X′ may be Cl or F. Alternatively, X′ may be Cl. Vacuum impregnation results in a physical mixture according to the following formula: zPdX_{q}+wSi→Pd_{z}Si_{w}X′_{zq}, where subscript z represents the molar amount of palladium atoms present in the mixture and subscript w represents the molar amount of silicon atoms present in the mixture. Alternatively, in these formulas, subscripts z and w may have values such that 0<z<1, 0<w<1, and a quantity (z+w)=1.

To perform step (1), the metal halide may be dissolved in a solvent, such as water or other polar protic solvent capable of dissolving the metal halide to form a solution. The selection of solvent will vary depending on factors such as the solubility of the metal halide chosen in the solvent, however, the solvent may comprise a primary alcohol such as methanol or ethanol in addition to, or instead of, the water. The amount of solvent used is sufficient to dissolve the metal halide. The exact amount depends on various factors including the metal halide selected and the solubility of the metal halide in solvent, however, the amount may range from 0.1% to 99.9%, alternatively 1% to 95%, based on the combined weight of metal halide and solvent. One single metal halide may be used in the solution. Alternatively, two or more metal halides, as described above, may be used in the solution.

One or more additional ingredients, such as an acid, an additional metal halide, or both, may optionally be added in the solution. The acid may be, for example, HCl. The amount of HCl may range from 0.1% to 1.0% based on the total weight of the solution.

The additional metal halide may be a copper halide such as a copper halide of formula CuX′, a copper halide of formula CuX′₂, or a combination thereof, where X′ is as described above. The copper halide may be added in an amount ranging from 0.01% to 0.99% based on total weight of metal halide used.

The silicon may have any convenient solid form, such as particulate. Ground silicon powder may be combined with the solution described above to form a slurry. Ground silicon powder with a particle size of less than 100 μm may be used. Ground silicon powder may have a purity >99.9%. Ground silicon powder is commercially available from sources such as Sigma-Aldrich, Inc. of St. Louis, Mo., U.S.A. The amount of ground silicon powder may range from 0.01% to 0.99%, alternatively >95%, and alternatively >90% based on the total weight of the metal halide.

Vacuum impregnation of the metal halide on the silicon may be performed by any convenient means, such as pulling vacuum on a container containing the slurry. Pressure for vacuum impregnation is below atmospheric pressure (vacuum sufficient enough for the metal halide solution to diffuse into, or interact with sites on, the surfaces of the Si particles). Pressure may be less than 102 kPa, alternatively 3.5 kPa to less than 102 kPa, alternatively 0.01 kPa to 4 kPa. Time for vacuum impregnation depends on various factors including the pressure chosen and the desired intermetallic product.

The slurry may be dried to form a powder. Drying may be performed by any convenient means, such as heating at atmospheric pressure or under vacuum. Drying may be performed at RT or with heating. Drying may be performed after step (1), concurrently with vacuum impregnation during step (1), or both. Time for drying depends on various factors including the solvent and amount of solvent selected, the pressure selected for vacuum impregnation, and how much solvent is removed during vacuum impregnation. However, drying may be performed by heating the slurry at 50° C. to 170° C., alternatively 100° C. to 140° C., for 1 h to 3 h, alternatively 1 h to 12 h, and alternatively 1 h to 24 h.

Step (2) of the method described above comprises mechanochemical processing of the mixture prepared in step (1). Step (2) involves a redox reaction of the components in the mixture according to the following formulas.

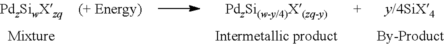

During mechanochemical processing a chemical reaction occurs, which is a redox reaction. Part of the silicon is oxidized to form volatile SiX′₄[when X=Cl or F] and part of the Si remains with the metal and remaining halide. When X 32 Br or I. SiX′4 by-product is not sufficiently volatile. It can be removed from the intermetallic product by chemical separation techniques, such as the use of a solvent. So, the combined amounts of Pd and Si in the intermetallic product change from a quantity (z+w) in the mixture formed in step (1) to (z+(w−y/4)), which is less than the quantity (z+w) by y/4, in the intermetallic product produced by step (2). The amount for y can be a proportion of the starting amount of halide. The starting amount of halide is zq. In this reaction y<zq. Alternatively, the quantity (z+w) may be equal to 1, and the combined amounts of Pd and Si in the intermetallic product may change from a quantity (z+w)=1 in the mixture formed in step (1) to a quantity (z+(w−y/4)), which is less than 1 by y/14.

Mechanochemical processing may be performed as described above. Mechanochemical processing parameters such as temperature, time, type of mill and type of balls used are selected to react the metal halide and the Si in the mixture. In common laboratory equipment, temperature for mechanochemical processing may range from RT to 40° C. Conventional equipment and techniques may be used, as described above. For example, ball milling may be performed in a stainless steel container by adding the product of step (1) and metal balls, such as stainless steel or tungsten balls, and milling for a time ranging from 0.15 h to 24 h, alternatively 0.15 h to 1 h, alternatively 2 h to 8 h, and alternatively 1 h to 24 h. Weight ratio of steel balls to powdered mixture obtained from step (1) may range from 5 to 50, alternatively 5 to 20, alternatively 10 to 15, and alternatively 30 to 50. The amount and size of the balls used for ball milling depends on various factors including the amount of mixture and the size of the container in which ball milling is performed, however, the balls may have a diameter ranging from 6 mm to 12 mm, alternatively 6.5 mm to 9.5 mm, and alternatively 9.5 mm to 12 mm.

The method described above may optionally comprise one or more additional steps. For example, the method may further comprise the step of activating the silicon before step (1). Activating the silicon may be performed, for example, by dissolving an ionic metal salt compound, such as CsF in a solvent, combining the resulting solution with the silicon as described above, and vacuum impregnating under conditions as described above for step (1). Alternatively, the ionic metal salt may be selected from the group consisting of KF, KCl, LiF, and KOH. The resulting activated silicon may optionally be dried as described above, and then used as a starting material in step (1). The method may optionally further comprise step (3), removing all or a portion of the by-product. The SiX′₄ by-product is volatile and may be removed from the intermetallic compound through heating or by exposure to a stream of air or inert gas such as nitrogen.

The product prepared by the method described above is a redox reaction product. The product comprises an intermetallic compound and a by-product comprising a silicon tetrahalide of formula SiX′₄, where X′ is as described above. The intermetallic compound may have formula Pd_{z}Si(_{w-y/4)}X′_{(zq-y)}, where a quantity (z+(w−/4)) represents the molar amount of silicon atoms remaining in the mixture and y represents a molar amount of halogen atom removed from the mixture during step (2), and y<zq. After step (2), the molar amounts of Si and X′ in the intermetallic compound are less than the molar amounts of Si and X′ present in the mixture in step (1); i.e., a quantity (zq−y)<zq because some of the silicon and halide form the by-product SiX′₄. Alternatively, the quantity (z+(w−y/4)) may have a value <1.

The intermetallic compound may comprise a palladium silicide. Alternatively, the intermetallic compound may comprise a species selected from the group consisting of PdSi; Pd₂Si; Pd_{z}Si_{(w-y/4)}X′_{(zq-y)}, where 0.01 zq<y<0.99 zq. Alternatively, the intermetallic compound may have more than one metal. For example, the intermetallic compound may comprise CuₙPdₘSi_{(w-y/4)}X′_{(zq-y)}; where n represents the molar amount of Cu, m represents a molar amount of Pd and 0.01 zq<y<0.99 zq. Alternatively, subscripts n, m, w, and z may have values such that a quantity (m+n)=z; (z+w)<1; 0<z<1; and 0 <w<1.

The intermetallic compound described above is useful as a catalyst for preparing an organohalosilane. A method of preparing an organohalosilane comprises: combining an organohalide having the formula RX″, where R is a hydrocarbyl group having 1 to 10 carbon atoms and X″ is a halogen atom, with a contact mass comprising at least 2% of the intermetallic compound described above at a temperature ranging from 250° C. to 700° C. to form the organohalosilane.

The hydrocarbyl groups represented by R in formula RX″ may have from 1 to 10 carbon atoms, alternatively from 1 to 6 carbon atoms, and alternatively from 1 to 4 carbon atoms. Acyclic hydrocarbyl groups containing at least three carbon atoms can have a branched or unbranched structure. Examples of hydrocarbyl groups include, but are not limited to, alkyl, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, octyl, nonyl, and decyl; cycloalkyl, such as cyclopentyl, cyclohexyl, and methylcyclohexyl; aryl, such as phenyl and naphthyl; alkaryl, such as tolyl, and xylyl; aralkyl such as benzyl and phenylethyl; alkenyl, such as vinyl, allyl, and propenyl; aralkenyl, such as styryl and cinnamyl; and alkynyl, such as ethynyl and propynyl. The halogen atom for X″ in the formula may be the same as, or different from, the halogen atom described above for X′ in the intermetallic compound. Alternatively, the halogen atom for X″ in the formula RX″ may be the same as the halogen atom described above for X′ in the intermetallic compound

Examples of organohalides include, but are not limited to, methyl chloride, methyl bromide, methyl iodide, ethyl chloride, ethyl bromide, ethyl iodide, chlorobenzene, bromobenzene, iodobenzene, vinyl chloride, vinyl bromide, vinyl iodide, allyl chloride, allyl bromide, and allyl iodide. Methods of preparing organohalides are known in the art; many of these compounds are commercially available.

The contact mass comprises at least 2%, alternatively at least 25%, alternatively at least 50%, alternatively at least 75%, alternatively at least 90%, alternatively at least 95%, alternatively about 100%, based on the total weight of the contact mass, of an intermetallic compound prepared as described above. The intermetallic compound may comprise a palladium silicide. Examples of palladium silicides include, but are not limited to, PdSi, Pd₂Si, Pd₃Si, Pd₅Si, and Pd₂Si₈. The palladium silicide may be a single palladium silicide or a mixture of two or more palladium silicides. Alternatively, the intermetallic compound may comprise Cu, Pd, and Si.

The contact mass may further comprise up to 98%, alternatively up to 75%, alternatively up to 50%, alternatively up to 25%, alternatively up to 10%, alternatively up to 5%, based on the total weight of the contact mass, zero-valent silicon. In another embodiment, the contact mass comprises essentially no zero-valent silicon. As used herein, “essentially no zero-valent silicon” is intended to mean that there is no zero-valent silicon other than at the level of an impurity. For example, essentially no zero-valent silicon means that there is from 0 to 1%, alternatively 0 to 0.5%, alternatively 0%, based on the total weight of the contact mass, zero-valent silicon.

The zero-valent silicon is typically chemical or metallurgical grade silicon; however, different grades of silicon, such as solar or electronic grade silicon may be used. Chemical and metallurgical grades of silicon are known in the art and can be defined by the silicon content. For example, chemical and metallurgical grades of silicon typically comprise at least 98.5% silicon. Chemical and metallurgical grades of silicon may also contain additional elements as described below for the contact mass. Methods of making zero-valent silicon are known in the art. These grades of silicon are available commercially.

The contact mass may comprise other elements such as Fe, Ca, Ti, Mn, Zn, Sn, Al, Pb, Bi, Sb, Ni, Cr, Co, and Cd and their compounds. Each of these elements may be present at an amount ranging from 0.0005% to 0.6% based upon the total weight of the contact mass.

The contact mass may be a variety of forms, shapes and sizes, up to several centimeters in diameter, but the contact mass is typically finely-divided. Finely divided, as used herein, is intended to mean that the contact mass is in the form of a powder.

The contact mass may be produced by standard methods for producing particulate silicon from bulk silicon, such as silicon ingots. For example, attrition, impact, crushing, grinding, abrasion, milling, or chemical methods may be used. Grinding is typical. The contact mass may be further classified as to particle size distribution by means of, for example, screening or by the use of mechanical aerodynamic classifiers such as a rotating classifier.

If the contact mass comprises more than a single intermetallic compound, for example if the contact mass comprises at least two intermetallic compound or an intermetallic compound and zero-valent silicon, these components may be mixed. The mixing may be accomplished by standard techniques known in the art for mixing solid particles. For example, the mixing may be accomplished by stirring or shaking. Further, mixing may be accomplished in the processing to produce the contact mass particle size mass distribution as described and exemplified above. For example, mixing may be accomplished in a grinding process. Still further, the mixing may be accomplished during the production of the intermetallic compound, such as the palladium silicide.

The method of the invention can be carried out in a suitable reactor for conducting the Direct Process. For example, a sealed tube, an open tube, a fixed bed, a stirred bed, or a fluidized bed reactor may be used.

The organohalide and contact mass may be combined by charging the reactor with the contact mass followed by flowing the gaseous organohalide through the contact mass. Alternatively, the reactor may be first charged with the organohalide followed by introduction of the contact mass.

The rate of addition of the organohalide to the contact mass is not critical; however, when using a fluidized bed, the organohalide is introduced into the reactor bed at a rate sufficient to fluidize the bed but below a rate that will completely entrain the bed. The rate will depend upon the particle size mass distribution of the particles in the bed and the dimensions of the fluidized bed reactor. One skilled in the art would know how to determine a sufficient rate of organohalide addition to fluidize the bed while not completely entraining the contact mass from the bed. When not using a fluidized bed, the rate at which the organohalide is added to the bed is typically selected to optimize contact mass reactivity.

The method may optionally further comprise combining the organohalide and contact mass in the presence of an inert gas. For example, an inert gas may be added with the organohalide to the contact mass. Examples of the inert gas that may be introduced with the organohalide include a gas selected from nitrogen, helium, argon and mixtures thereof. The method may optionally further comprise a step of activating the contact mass before and/or during combining the organohalide and contact mass, as described above. Activating the contact mass may be performed by exposing the contact mass to hydrogen gas, or a combination of the inert gas and hydrogen gas, at a temperature ranging from 200° C. to 600° C. for a time ranging from 30 min to 6 h, alternatively 30 min to 4 h.

The method may be conducted with agitation of the reactants. Agitation may be accomplished by methods known in the art for catalyzed reactions between gases and solids. For example, reaction agitation may be accomplished within a fluidized bed reactor, in a stirred bed reactor, a vibrating bed reactor and the like. However, the method may be conducted without agitation of the reactants by, for example, flowing the organohalide as a gas over a packed bed comprising the intermetallic compound.

The method may be carried out at atmospheric pressure conditions, or slightly above atmospheric pressure conditions, or elevated pressure conditions may be used.

The temperature at which the contact mass and organohalide are combined may range from 250° C. to 750° C., alternatively 280° C. to 700° C., alternatively 300° C. to 700° C., and alternatively 400° C. to 700° C. The temperature at which the contact mass and organohalide are combined may influence the selectivity of the method for producing monoorganohalosilane or diorganohalosilane in the organohalosilane product. The composition of the intermetallic compound may also influence the selectivity of the method for producing monoorganohalosilane or diorganohalosilane. Without wishing to be bound by theory, it is thought that an intermetallic compound containing a relatively high amount of the palladium silicide of formula PdSi may selectively produce an organohalosilane comprising a diorganodihalosilane and an intermetallic compound containing a relatively high amount of the palladium silicide of formula Pd₂Si may selectively produce an organohalosilane comprising monoorganotrihalosilane. The selectivity may be determined by gas chromatography, or through other suitable analytical techniques.

The contact mass and organohalide are typically combined for sufficient time to form an organohalosilane from the reaction of the intermetallic compound with the organohalide. For example, in a batch-type reactor, the contact mass and organohalide may be combined for a contact time ranging from 5 minutes to 24 h, alternatively 1 h to 7 h, alternatively 4 h to 7 h, at a temperature ranging from 300° C. to 700° C. In a continuous or semi-continuous process, where additional contact mass may be added to the reactor, and organohalide gas is continuously passed through the contact mass, the contact time may range from a fraction of a second up to 30 seconds, alternatively from 0.01 second to 15 seconds, alternatively from 0.05 second to 5 seconds.

When the organohalide is a liquid or solid, the method may optionally further comprise pre-heating and gasifying the organohalide before it is introduced into the reactor.

The method may optionally further comprise pre-heating the contact mass in an inert atmosphere and at a temperature up to 700° C., alternatively up to 400° C., alternatively 280° C. to 525° C., prior to contacting with the organohalide.

The method may optionally further comprise introducing additional contact mass or zero-valent silicon into the reactor to replace the silicon that has reacted with the organohalide to form organohalosilanes.

The method may optionally further comprise recovering the organohalosilane produced. The organohalosilane may be recovered by, for example, removing gaseous organohalosilane from the reactor followed by condensation. The organohalosilane may be recovered and a mixture of organohalosilanes separated by distillation.

The organohalosilanes prepared according to the present method typically have the formula R′_{q}SiX″_{4-q}, where each R′ is independently H or as described and exemplified above for R in the organohalide of formula RX″, and X″ is as described and exemplified above for the organohalide, and the subscript “q” is an integer with a value of 0 to 3, alternatively 1 to 3.

Examples of organohalosilanes prepared according to the present method include, but are not limited to, dimethyldichlorosilane (i.e., (CH₃)₂SiCl₂), dimethyldibromosilane, diethyldichlorosilane, diethyldibromosilane, trimethylchlorosilane (i.e., (CH₃)₃SiCl), methyltrichlorosilane (i.e., (CH₃)SiCl₃), phenyltrichlorosilane, diphenyldichlorosilane, triphenylchlorosilane, and methylhydrodichlorosilane (i.e., (CH₃)HSiCl₂. The method may also produce small amounts of halosilane and organosilane products such as trichlorosilane, tetrachlorosilane, and tetramethylsilane.

The method described above can produce organohalosilanes from a silicon source other than zero-valent silicon and produces commercially desirable organohalosilanes in good yield and proportion to less desirable silanes.

The organohalosilanes produced by the present method are the precursors of most of the products in the silicone industry. For example, dimethyldichlorosilane may be hydrolyzed to produce linear and cyclic polydimethylsiloxanes. Other organohalosilanes, such as methyltrichlorosilane, produced by the method may also be used to make other silicon-containing materials such as silicone resins or sold into a variety of industries and applications.

### EXAMPLES

These examples are intended to illustrate some embodiments of the invention and should not be interpreted as limiting the scope of the invention set forth in the claims.

### Example A

### Intermetallic Compound Preparation and Analysis

An amount of metal chloride was dissolved in 0.3 mL distilled water. Ground silicon powder with particle size less than 100 μm was added, and the resulting composition was vacuum impregnated for 1 h at room temperature of 23° C. and pressure of 4 kPa to form a slurry.

The slurry was dried at 120° C. for 2 h, and a fine black powder was obtained. The powder was ball milled using a SPEX 8000 mixer/mill in a stainless steel container with 12 mm diameter stainless steel balls under a nitrogen atmosphere. After ball milling, the resulting solid was retrieved and analyzed by XRD and SEM/EDS.

### Examples 1-5

Samples were prepared and analyzed according to the method of Example A. The metal chloride selected, the amounts of metal chloride and ground silicon, the molar ratio of silicon to metal chloride, the amount of powder ball milled, the time the powder was ball milled, and the weight ratio of steel balls to powder are shown below in Table 2, and the results are in Table 3.

TABLE 2
Experimental Conditions for Examples 1-5

| | | | | Molar | Amt. of | Time | Weight |
|---|---|---|---|---|---|---|---|
| | | | | ratio of | Powder | for | Ratio of |
| | | Metal | Ground | Silicon | added | Ball | Steel |
| | Metal | Chloride | Si Amt. | to Metal | to Ball | Milling | Balls and |
| Ex. | Chloride | Amt. (g) | (g) | Chloride | Mill (g) | (h) | Powder |
| 1 | PdCl₂ | 0.61 | 0.61 | 6.3 | 0.45 | 2 | 15 |
| 2 | PdCl₂ | 0.61 | 0.61 | 6.3 | 0.45 | 8 | 15 |
| 3 | PdCl₂ | 0.47 | 0.075 | 1.0 | 0.55 | 8 | 13 |
| 4 | PdCl₂ | 0.47 | 0.15 | 2.0 | 0.62 | 8 | 11 |
| 5 | PdCl₂ | 0.47 | 0.11 | 1.5 | 0.58 | 8 | 12 |

TABLE 3
Results of Experiments in Table 2

| Example | Results |
|---|---|
| 1 | Analytical data suggested loss of chloride, and based on EDS elemental |
| | mapping, the sample showed a composition containing Pd_{2.7}Si_{17.2}Cl₂₄ with a |
| | stoichiometry corresponding to Pd₁Si_{6.37}Cl_{0.88}. This corresponded to an |
| | estimate of 53.2 mol % Si loss and 61.4 mol % chloride loss. XRD data suggested |
| | the sample contained crystalline phase Pd₂Si (52 mol %) and PdSi (21 mol %) as |
| | well as the presence of Si and Pd (balance). |
| 2 | Analytical data suggested loss of chloride, and based on EDS elemental |
| | mapping, the sample showed a composition containing Pd_{6.9}Si_{39.8}Cl_{1.9} with a |
| | stoichiometry corresponding to Pd₁Si_{5.7}Cl_{0.27}. This corresponded to an |
| | estimate of 57.6 mol % Si loss and 88 mol % chloride loss. XRD data suggested |
| | the sample contained crystalline phase Pd₂Si (23 mol %) and PdSi (47 mol %) as |
| | well as the presence of Si (balance). |
| 3 | Analytical data suggested loss of chloride, and based on EDS elemental |
| | mapping, the sample showed a composition containing Pd_{32.1}Si_{21.5}Cl_{4.0} with |
| | a stoichiometry corresponding to Pd₁Si_{0.67}Cl_{0.12}. XRD data suggested the |
| | sample contained crystalline phase Pd₂Si (>90 mol %) and Pd(balance) with no |
| | silicon left behind. |
| 4 | Analytical data suggested loss of chloride, and based on EDS elemental |
| | mapping, the sample showed a composition containing Pd₂₇Si_{31.2}Cl_{2.1} with a |
| | stoichiometry corresponding to Pd₁Si_{1.15}Cl_{0.08}. XRD data suggested the |
| | sample contained crystalline phase Pd₂Si (65 mol %), and PdSi (31 mol %) as |
| | well as presence of silicon (balance) with no palladium left behind. |
| 5 | Analytical data suggested loss of chloride, and based on EDS elemental |
| | mapping, the sample showed a composition containing Pd₂₁Si_{26.2}Cl_{3.1} with a |
| | stoichiometry corresponding to Pd₁Si_{1.25}Cl_{0.148}. XRD data suggested the |
| | sample contained crystalline phase PdSi (93 mol %), and Pd₂Si (7 mol %) with no |
| | silicon and palladium left behind. |

### Example 6

A sample was prepared according to the method of Example A. After the ball milling process was complete, the lid on the steel vial containing the sample was opened and a piece of pH paper shown into it turned red. ICP analysis on the solid retrieved showed loss of chloride (92 mol %) and loss of Si (42 mol %) as volatile species (SiCl₄). Based on the elemental analyses, the solid composition had a stoichiometry corresponding to Pd₁Si_{0.67}Cl_{0.136}. XRD results indicated that Pd₂Si was present.

TABLE 4
Example 6 conditions

| | | | | Molar | Amt. of | Time | Weight |
|---|---|---|---|---|---|---|---|
| | | | Ground | ratio of | Powder | for | Ratio of |
| | | Metal | Si | Silicon to | added | Ball | Steel |
| | Metal | Chloride | Amt. | Metal | to Ball | Milling | Balls and |
| Ex. | Chloride | Amt. (g) | (g) | Chloride | Mill (g) | (h) | Powder |
| 6 | PdCl₂ | 0.8 | 0.13 | 1.0 | 0.6 | 8 | 12 |

### Example B

### Two Step Sample Preparation and Analysis

An amount of CsF (0.3 g) was dissolved in 0.3 mL distilled water; and 0.57 g of ground silicon powder with particle size less than 100 pm was added. The resulting composition was vacuum impregnated for 1 h at room temperature of 23° C. and pressure of 4 kPa to form a slurry mixture. The slurry mixture was dried at 120° C. for 2 h, and an activated silicon was obtained.

PdCl₂ and CuCl₂ were dissolved in 0.3 mL of distilled water, and the resulting solution was added to 0.9 g of the activated silicon. The resulting mixture was vacuum impregnated for 1 h at room temperature of 23° C. and pressure of 4 kPa and subsequently dried at 120° C. for 2 h.

The resulting powder was ball milled using a SPEX 8000 mixer/mill in a stainless steel container with 12 mm diameter stainless steel balls under a nitrogen atmosphere. After ball milling, the resulting solid mixture was retrieved and analyzed by XRD and SEM/EDS.

### Examples 7 and 8

Samples were prepared according to the method of Example B. The amounts of PdCl₂ and CuCl₂, the amount of powder ball milled, the time the powder was ball milled, and the weight ratio of steel balls to powder, and the results are shown below in Table 5.

TABLE 5
Conditions and Results for Examples 7 and 8

| | | | Amt. of | Time for | Wt. Ratio | |
|---|---|---|---|---|---|---|
| | PdCl₂ | CuCl₂ | Powder | Ball | of Balls | |
| | Amt. | Amt | added | Milling | & | |
| Ex. | (g) | (g) | to Ball Mill (g) | (h) | Powder | Composition |
| 7 | 0.5 | 0.1 | 0.5 | 2 | 14 | Cu_{0.18}Pd_{1.82}Si (42 mol %), |
| | | | | | | CsCl (8 mol %) and Si |
| | | | | | | (51 mol %). |
| 8 | 0.5 | 0.1 | 0.5 | 8 | 14 | Cu_{0.18}Pd_{1.82}Si (31 mol %), |
| | | | | | | PdSi (8 mol %), CsCl |
| | | | | | | (18 mol %) and Si (42 mol %). |

### Example 9

### Chlorosilane Production

An intermetallic compound was prepared using a method as described above in example 5, and 0.5 g was loaded into a quartz tube flow through reactor. The reactor was initially purged with argon for 1 h. The sample was treated with H₂ (20 sccm) at 500° C. for 2 h and subsequently the reactor temperature was reduced to 300° C. H₂ flow was stopped followed by purging with argon. Next, MeCl (1 sccm) was flowed through the sample bed, and the evolution of volatiles were analyzed by combination of GC and GC-MS. At 300° C., high selectivity towards Me₂SiCl₂ (76 mol %) was observed, with the rest as MeSiCl₃ (24 mol %). As the reaction continued, the selectivity of the reaction for producing Me₂SiCl₂ dropped and a 1:1 ratio of Me₂SiCl₂/MeSiCl₃ was observed at 350° C. after 1 h. Continuing the reaction at 400° C. for 1 h lead to significant drop in Me₂SiCl₂ selectivity and product composition contained Me₂SiCl₂ (10 mol %), MeSiCl₃ (77 mol %) and SiCl₄(13 mol %).

### Example 10

### Chlorosilane Production

An intermetallic compound was prepared by the method as described above in example 8, and 0.5 g was loaded into a quartz tube flow through reactor. The reactor was initially purged with argon for 1 h. The sample was treated with H₂ (20 sccm) at 500° C. for 2 h and subsequently the reactor temperature was reduced to 300° C. Hydrogen flow was stopped, followed by purging with argon. Next, MeCl (1 sccm) was flowed through the sample bed and the evolution of volatiles were analyzed by combination of GC and GC-MS. At 300° C., Me₂SiCl₂ (83 mol %) was observed along with MeSiCl₃ (11 mol %) and Me₃SiCl (6 mol %). As the reaction continued at 300° C., the selectivity of the reaction for producing Me₂SiCl₂ dropped, and after 1 h, it reduced to 13mol % Me₂SiCl₂ and the rest as MeSiCl₃ (82 mol %) and SiCl₄ (5 mol %). At 350° C. and higher, Me₂SiCl₂ production stopped. At 400° C., the product composition contained MeSiCl₃ (83 mol %) and SiCl₄ (17 mol %).

### Comparative Examples 1 and 2

### Omit Ball Milling Step

Samples of the fine black powders obtained by drying the slurry mixtures prepared in examples 1 and 7 were analyzed by XRD and SEM/EDS before ball milling. In each comparative example, analytical data suggested the presence of Si and metal chlorides, indicating binary/ternary silicide did not form. For the slurry from example 1, which produced PdCl₂/Si sample (C1), EDS elemental mapping on the sample showed a composition containing Pd_{4.9}Si_{66.7}Cl_{11.2}, with a stoichiometry corresponding to Pd₁Si_{13.6}Cl_{2.28}. For the slurry from example 7, which produced PdCl₂-CuCl₂/Si sample (C2), EDS elemental mapping on the sample showed a composition containing Pd₃Cu_{0.5}Si_{50.3}Cl₇, with a stoichiometry corresponding to Pd₁Cu_{0.29}Si_{7.29}Cl_{1.13}.

The intermetallic compounds described herein are useful as catalysts for preparing organohalosilanes. PdSi is useful as a selective catalyst for forming diorganodihalosilanes. The intermetallic compound comprising PdSi formed by the method described herein may be used in the methods for preparing diorganodihalosilanes mentioned in WO2011/094140 and WO2011/149588, which are both hereby incorporated by reference. The intermetallic compound comprising Pd₂Si is useful as a selective catalyst for forming monoorganotrihalosilanes.

The process described herein may be used to selectively control the stoichiometry of the intermetallic compound produced. Without wishing to be bound by theory, it is thought that formation of PdSi over Pd₂Si may be optimized by controlling the molar ratio of palladium halide and silicon used in step (1) of the process described herein, for example Si:PdX′₂ molar ratio may be greater than 2:1, alternatively 2:1 to 1.5:1. Without wishing to be bound by theory, it is thought that mechanochemical processing in step (2) of the method described above offers the advantage of not requiring extreme temperatures as compared to an electrochemical method or high temperature arc melting process, which may require extreme temperatures.

1. A process comprises:
(1) vacuum impregnating a metal halide on silicon, where the metal halide comprises a palladium halide of formula PdX′₂, where each X′ is independently a halogen atom, thereby producing a mixture comprising Pd_{z}Si_{w}X′_{zq}, where z represents a molar amount of Pd, w represents a molar amount of Si and zq represents a molar amount of the halogen atoms in the mixture; and
(2) mechanochemically processing the mixture under an inert atmosphere, thereby producing a redox reaction product comprising
(i) an intermetallic compound of formula Pd_{z}Si_{(w-y/4)}X′_{(zq-y)}where y represents a molar amount of halogen atom removed from the mixture during step (2), and y<zq; and
(ii) a by-product comprising SiX′₄.

2. The process of claim 1, where in step (1), 0<z<1, 0<w<1, and a quantity (z+w)=1; and in step (2), a quantity (z+(w−y/4))<1.

3. The process of claim 1, where a molar ratio of Si to PdX′₂ is at least 1:1, or where the molar ratio of Si to PdX′₂ is at least 1.5:1, or where the molar ratio of Si to PdX′₂ is from 1.5:1 to 10:1.

4. The process of claim 1, further comprising:
step (3) removing all or a portion of the by-product, or
step (0) activating the silicon before step (1), or
both step (3) and step (0).

5. The process of claim 1, where in addition to the metal halide of formula PdX′₂, the metal halide further comprises a copper halide selected from the group consisting of CuX′, CuX′₂, and a combination thereof.

6. An intermetallic compound prepared by the process of claim 5, wherein the intermetallic compound comprises CuₙPdₘSi_{(w-y/4)}X′_{(zq-y)}; where n represents a molar amount of Cu, m represents a molar amount of Pd, zq represents a relative molar amount of halogen atoms in the mixture formed in step (1), y represents a molar amount of halogen atoms removed from the mixture during step (2), y/4 represents a molar amount of Si removed from the mixture during step (2), and 0.01 zq<y<0.99 zq, and 0<w<1.

7. A method comprising:
combining an organohalide having the formula RX″, where R is a hydrocarbyl group having 1 to 10 carbon atoms and X″ is a halogen atom, with a contact mass comprising at least 2% of the intermetallic compound of claim 6 at a temperature from 250° C. to 750° C. to form an organohalosilane.

8. The method of claim 7, where the hydrocarbyl group has 1 to 6 carbon atoms and X″ is Cl; or where the organohalide is methyl chloride, methyl bromide, or methyl iodide.

9. The method of claim 7, where the contact mass comprises at least 25% of the intermetallic compound.

10. The method of claim 9, further comprising replenishing the contact mass with a zero-valent silicon or with additional contact mass as the organohalosilane is produced.

11. The method of claim 7, further comprising a step of: activating the contact mass.

12. The process of claim 2, where a molar ratio of Si to PdX′₂ is at least 1:1, or where the molar ratio of Si to PdX′₂ is at least 1.5:1, or where the molar ratio of Si to PdX′₂ is from 1.5:1 to 10:1.

13. The process of claim 2, further comprising:
step (3) removing all or a portion of the by-product, or
step (0) activating the silicon before step (1), or
both step (3) and step (0).

14. The process of claim 3, further comprising:
step (3) removing all or a portion of the by-product, or
step (0) activating the silicon before step (1), or
both step (3) and step (0).

15. The process of claim 2, where in addition to the metal halide of formula PdX′₂, the metal halide further comprises a copper halide selected from the group consisting of CuX′, CuX′₂, and a combination thereof.

16. The process of claim 3, where in addition to the metal halide of formula PdX′₂, the metal halide further comprises a copper halide selected from the group consisting of CuX′, CuX′₂, and a combination thereof.

17. The process of claim 4, where in addition to the metal halide of formula PdX′₂, the metal halide further comprises a copper halide selected from the group consisting of CuX′, CuX′₂, and a combination thereof.

18. The process of claim 11, where activating the contact mass is performed by a technique comprising exposing the contact mass to hydrogen at a temperature of 200° C. to 600° C. for a time ranging from 30 min to 6 h.
